(19) United States
(12) Patent Application Publication
(10) Pub. No.: US 2005/0137072 A1
(43) Pub. Date: Jun. 23, 2005

(54) Box-erecting machine

(76) Inventor: Granville Henry Mason Jackson, Durban (ZA)

Correspondence Address: OSTROLENK FABER GERB & SOFFEN, 1180 AVENUE OF THE AMERICAS, NEW YORK, NY, 100368403, US

(21) Appl. No.: 10/991,979

(22) Filed: Nov. 18, 2004

(30) Foreign Application Priority Data
Nov. 18, 2003 (ZA) 2003/8960

(51) Int. Cl. B31B 1/44

(52) U.S. Cl. 493/171

(57) ABSTRACT

A box-erecting machine comprising a support structure and a rotatable head mounted on the support structure for rotation about an axis, the rotatable head carrying a plurality of four-cornered mandrels, means for displacing each mandrel away from and towards the rotatable head, and means for rotating the rotatable head in discrete steps so as to locate each mandrel at consecutive erecting stations of the machine and thereby to permit progressive erection of a rectangular box through the erecting stations from a blank of sheet-like material with corner posts located and connected in each of the four corners of the box.

### FIELD OF THE INVENTION

This invention relates to a box-erecting machine and more particularly to such a machine that operates semi-automatically.

The type of box or crate (hereinafter referred to as a box) which the machine of the invention is used to erect, has a rectangular configuration and is made from a diecut and creased blank of sheet material. The blank could be made of cardboard or of a polymeric material such as polyethylene. The box is further characterized in that it has an elongate upright corner post at each of its four corners, providing the essential strength of the box at its corners. Such a box is useful for stacking, one upon another. Each corner post consists of an inner part located in the inside of the box and an outer part located on its outside, the two parts being joined so as to trap and hold the walls of the box in position and generally providing rigidity to the box.

The invention is therefore concerned with a machine for semi-automatically erecting a rectangular box of this kind.

### BACKGROUND TO THE INVENTION

The design and operation of packaging machinery are as diverse as the numerous types of packaging encountered in the packaging industry.

In the case of the present invention, the applicant is not aware of a box-erecting machine, semi-automatic or otherwise, which is capable of carrying out the erection of a box of the kind described above. Hitherto, the applicant has used certain jigs and tools operated by hand in order to install the four corner posts in the corners of a box of the type in question. This has proved to be laborious and time consuming and, indeed, the applicant believes that such manual erection of boxes will not meet the requirements of modern pack-houses where agricultural produce, for example, is packed in large quantities in relatively short periods of time.

### OBJECT OF THE INVENTION

It is accordingly an object of the invention to provide a semi-automatic box-erecting machine which is capable of efficiently erecting boxes of the type described above at a rate in the order of 360 boxes per hour or more.

### SUMMARY OF THE INVENTION

A box-erecting machine according to the invention comprises a support structure and a rotatable head mounted on the support structure for rotation about an axis, the rotatable head carrying a plurality of four-cornered mandrels, means for displacing each mandrel away from and towards the rotatable head, and means for rotating the rotatable head in discrete steps so as to locate each mandrel at consecutive erecting stations of the machine and thereby to permit progressive erection of a rectangular box through the erecting stations from a blank of sheet-like material with corner posts located and connected in each of the four corners of the box.

Each mandrel may comprise a plurality of displaceable parts defining the corners of the mandrel, each mandrel being expandable to an expanded configuration in which the corners are located in a pre-determined expanded formation, and contractable to a contracted configuration in which the corners are located in a pre-determined contracted formation.

More particularly, the plurality of erecting stations of the machine may comprise;
a first erecting station at which an inner part of a corner post is locatable on each of the four corners of a mandrel;
a second erecting station including a platform surrounding a blank-folding cavity, the mandrel being displaceable into the cavity to fold a blank located on the platform into a rectangular box consisting of a base, two opposed side walls and two opposed end walls, the mandrel being expandable within the cavity to its expanded configuration to locate the inner parts of the corner posts in the four inner corners of the rectangular box, the mandrel, with the box, being displaceable from the box-folding cavity;
a third erecting station including four post-holding devices, an outer part of a corner post being locatable in each post-holding device, the mandrel, carrying the box, being displaceable into alignment with the post-holding devices, the post-holding devices being simultaneously displaceable towards the mandrel to connect each outer part of each post with its respective inner part located in the box and thereby to trap and hold the walls of the box by means of the corner posts, the post-holding devices being retractable and the mandrel being displaceable from its position adjacent the post-holding devices; and
a fourth erecting station including a receiving platform, the mandrel being displaceable to locate the box on the receiving platform, the mandrel being contractable to its contracted configuration, thereby releasing it from the box, the mandrel being displaceable from the receiving platform, and box-ejecting means being provided for ejecting the box from the receiving platform onto a conveyor or the like.

The rotating head preferably comprises four equally spaced radial arms each carrying a mandrel in dependent fashion. Each mandrel may be mounted on its associated arm by means of a pair of vertical shafts for vertical displacement relative to the support structure of the machine and may comprise a hub carried by the vertical shafts and a pair of opposed cheek plates defining the four corners of the mandrel, the cheek plates being mounted for horizontal displacement away from and towards the central part to permit expansion and contraction of the mandrel respectively.

The means for displacing each mandrel may comprise a pneumatic piston and cylinder assembly mounted between each pair of shafts.

The means for rotating the rotating head may comprise electric drive means arranged to rotate the rotatable head through consecutive 90° steps in an indexing fashion to locate each mandrel consecutively at each erecting station of the machine.

The invention also contemplates a method of erecting a box comprising,
providing a box-erecting machine having a support structure and a rotatable head mounted on the support structure for rotation about an axis, the rotatable head carrying a plurality of four-cornered mandrels, means for displacing each mandrel away from and towards the rotatable head, and means for rotating the rotatable head,
rotating the head in discrete steps so as to locate each mandrel at consecutive erecting stations of the machine, and
progressively erecting the box through the erecting stations from a blank of sheet-like material to provide corner posts located and connected in each of the four corners of the box.

A preferred embodiment of the invention will now be described by way of example only, with reference to the accompanying drawings in which;

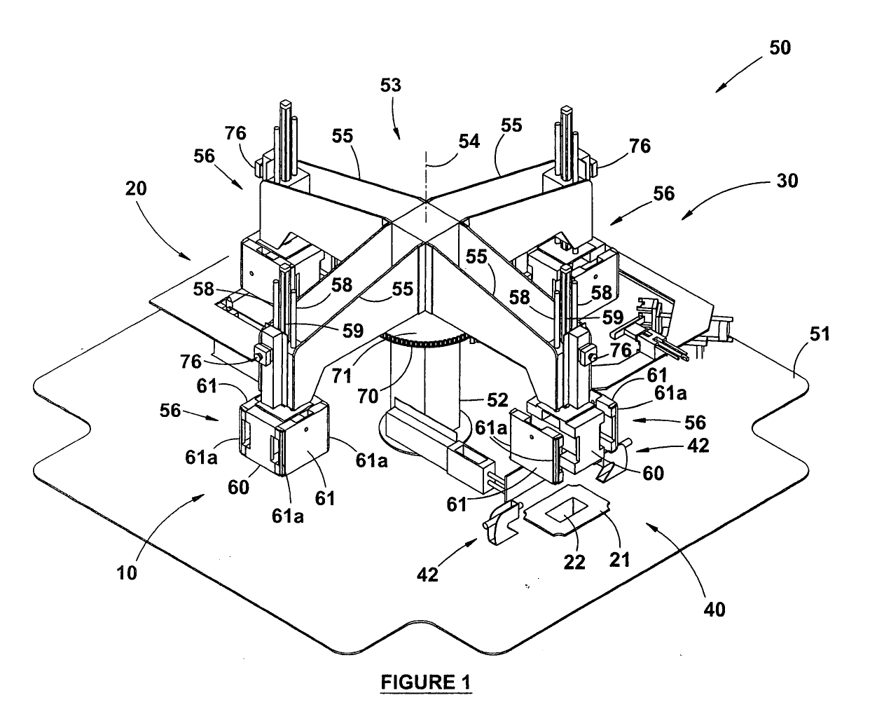

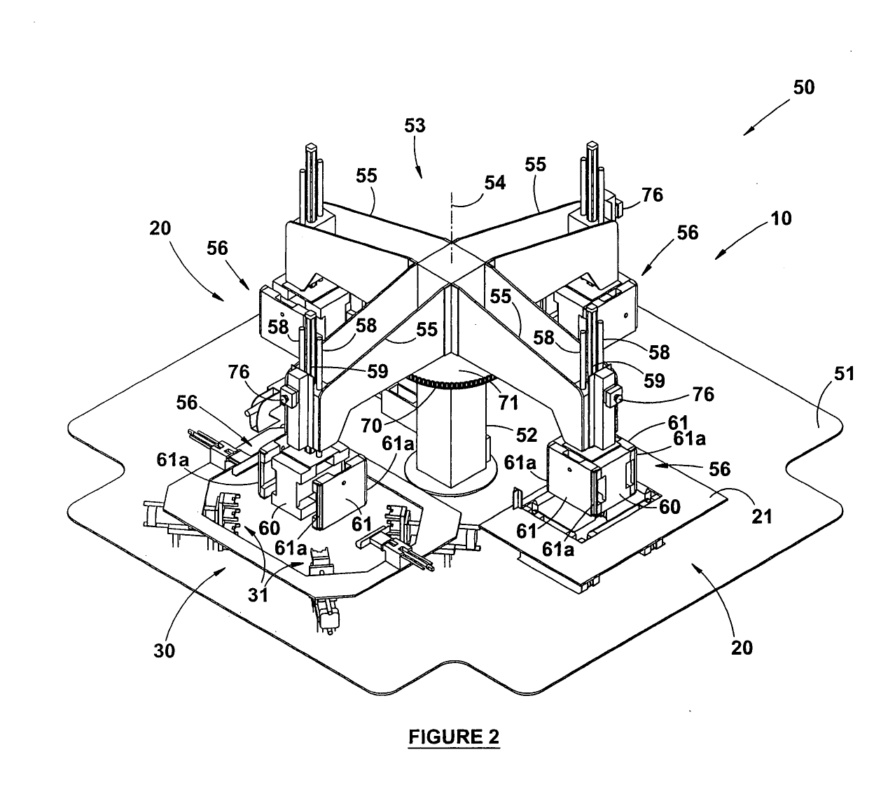

FIGS. 1 and 2 are perspective views from opposite sides respectively of a box-erecting machine showing its main components;

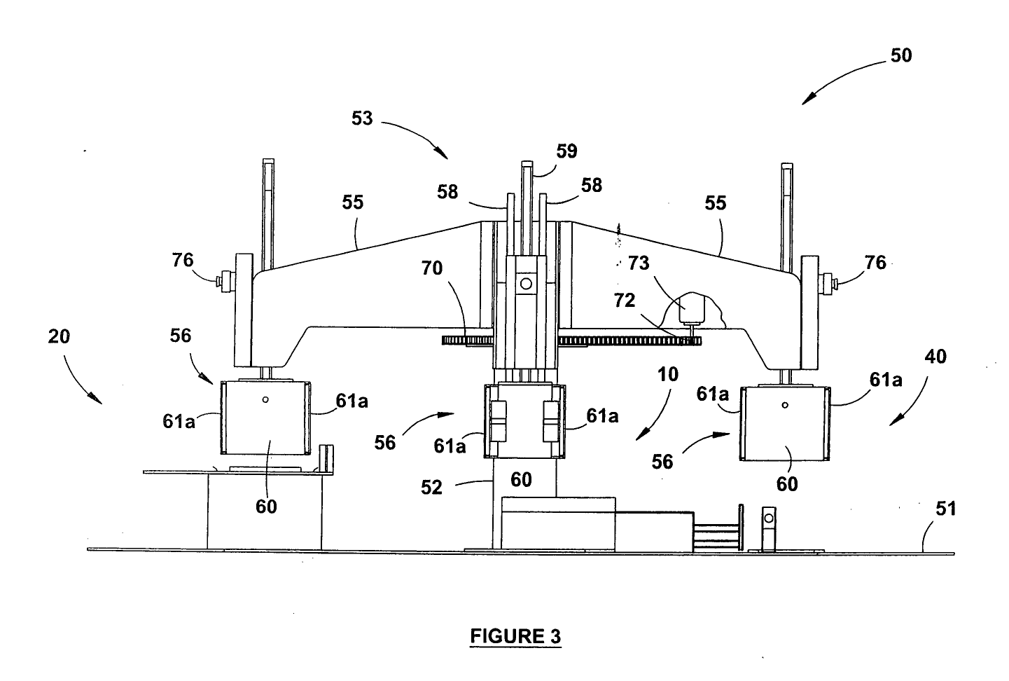

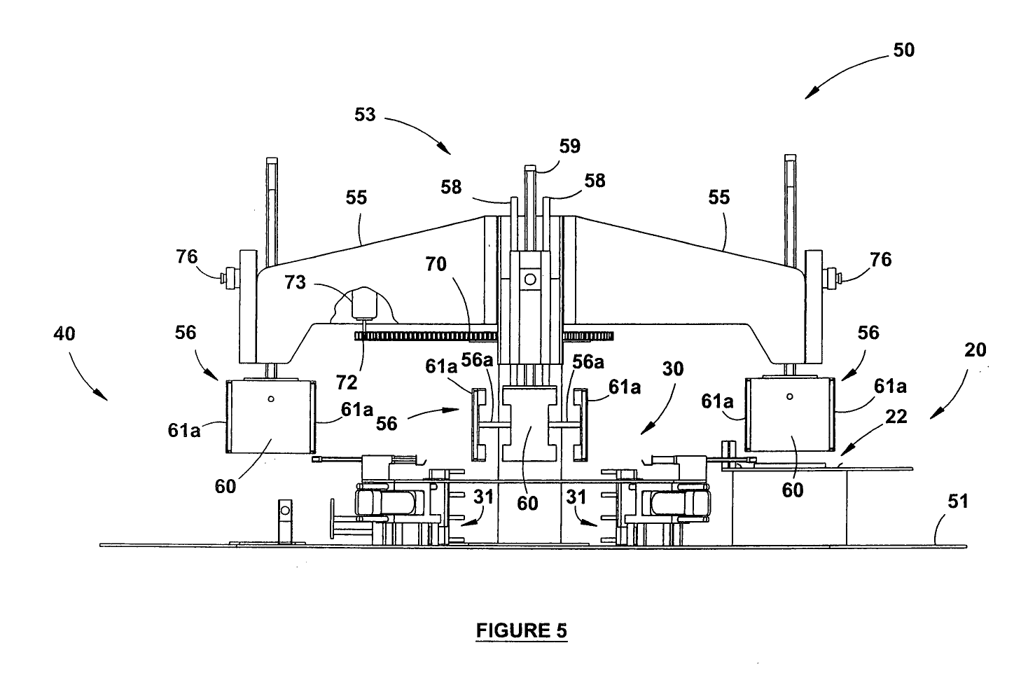

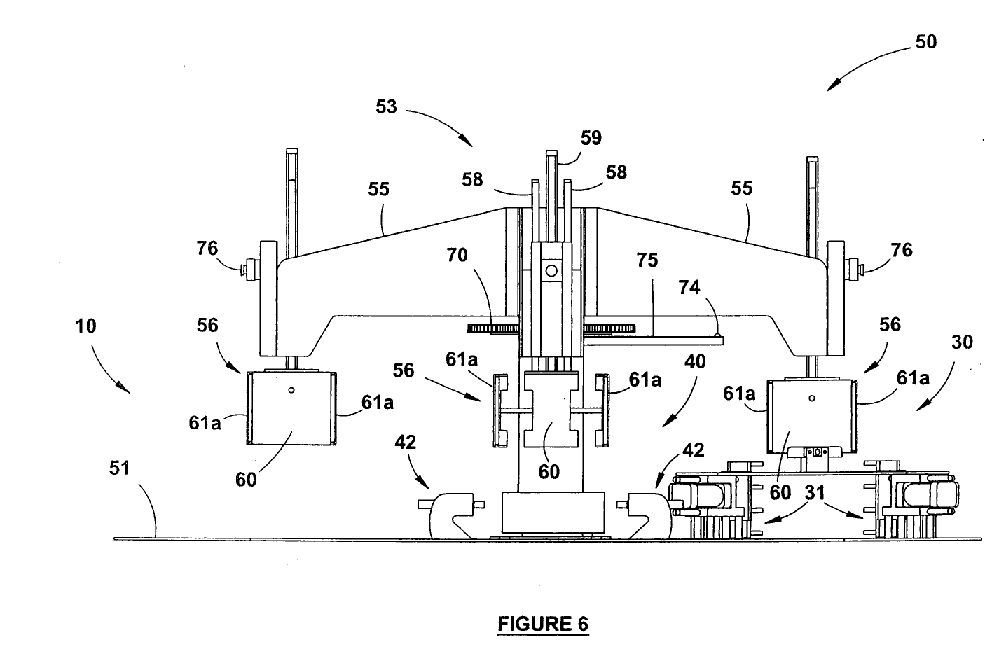

FIGS. 3-6 are side views of the machine showing each one of four erecting stations of the machine;

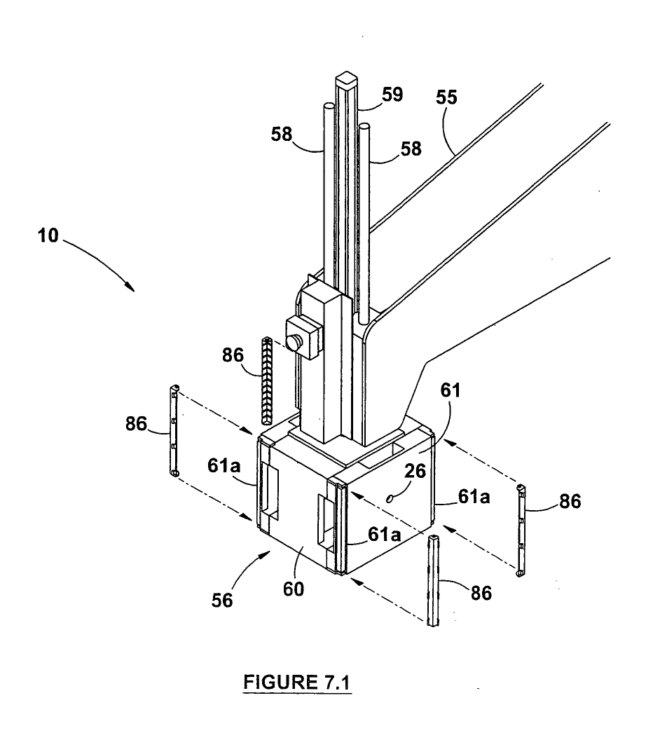

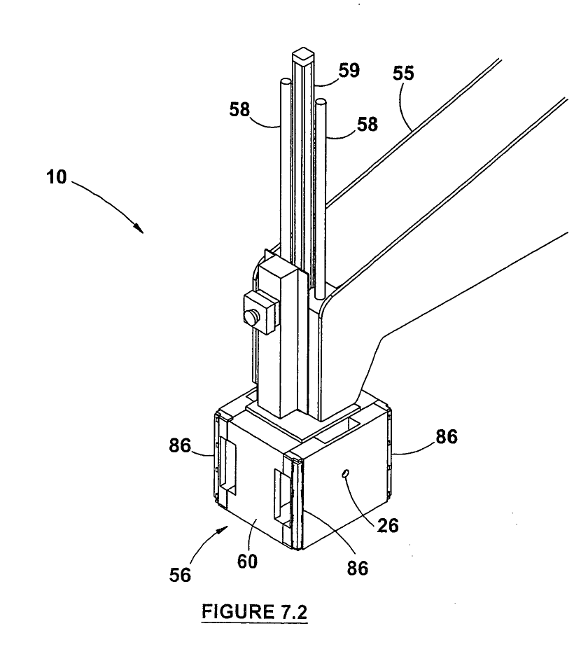

FIGS. 7.1-7.2 illustrate the operations at a first erecting station of the machine;

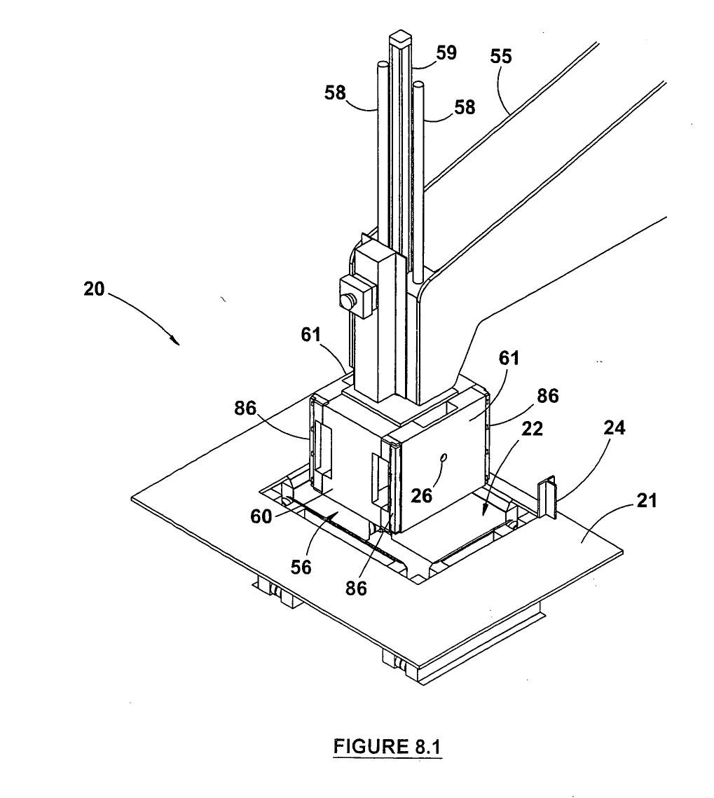

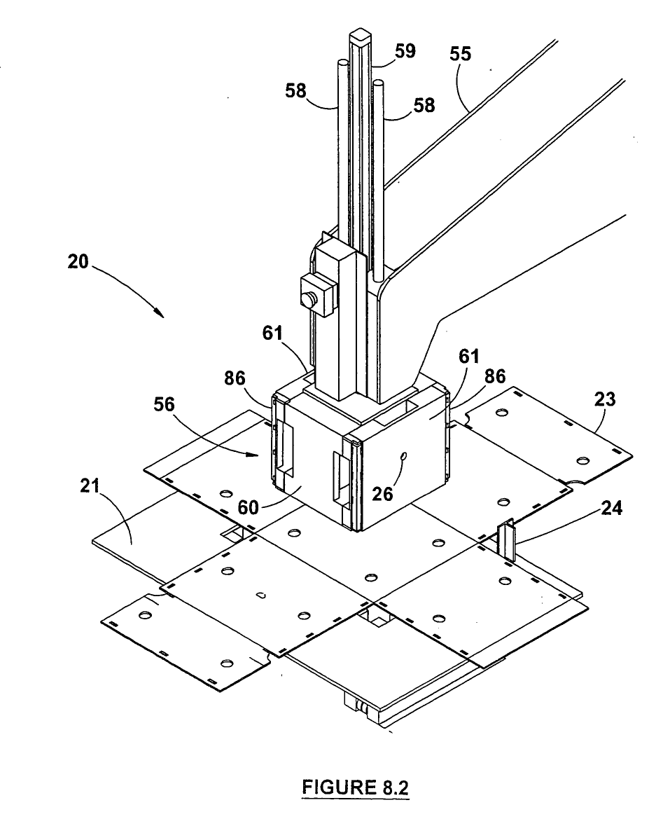

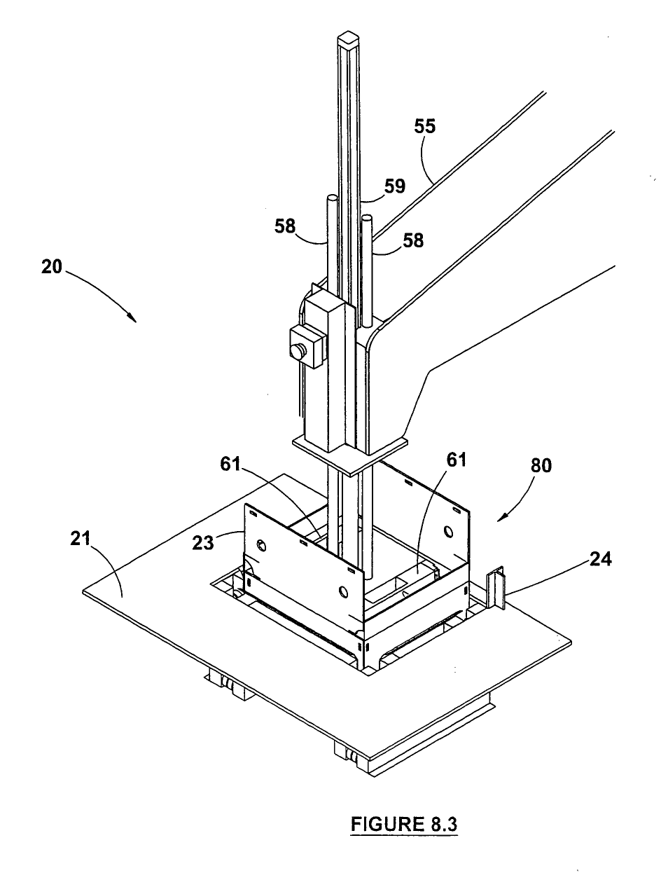

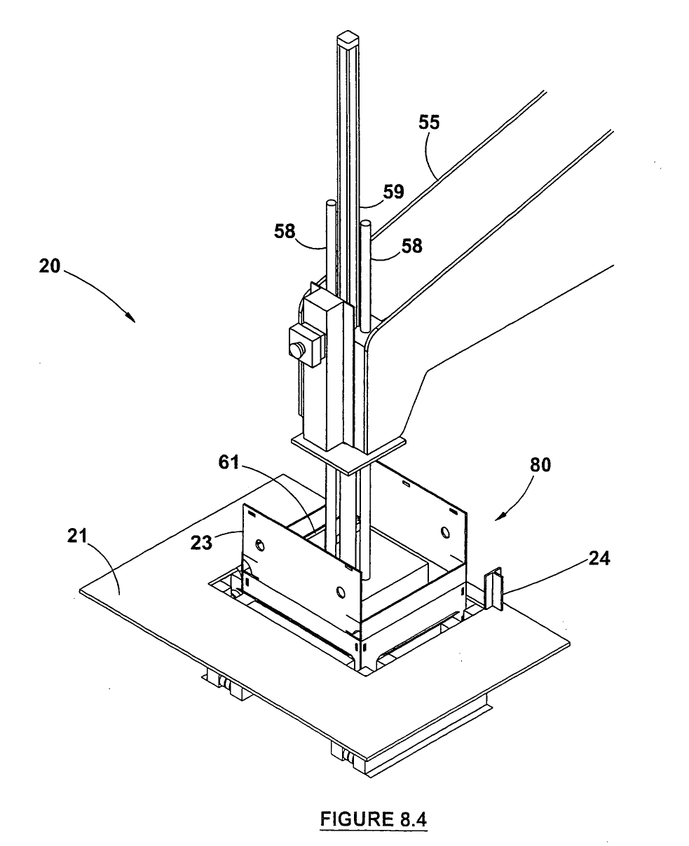

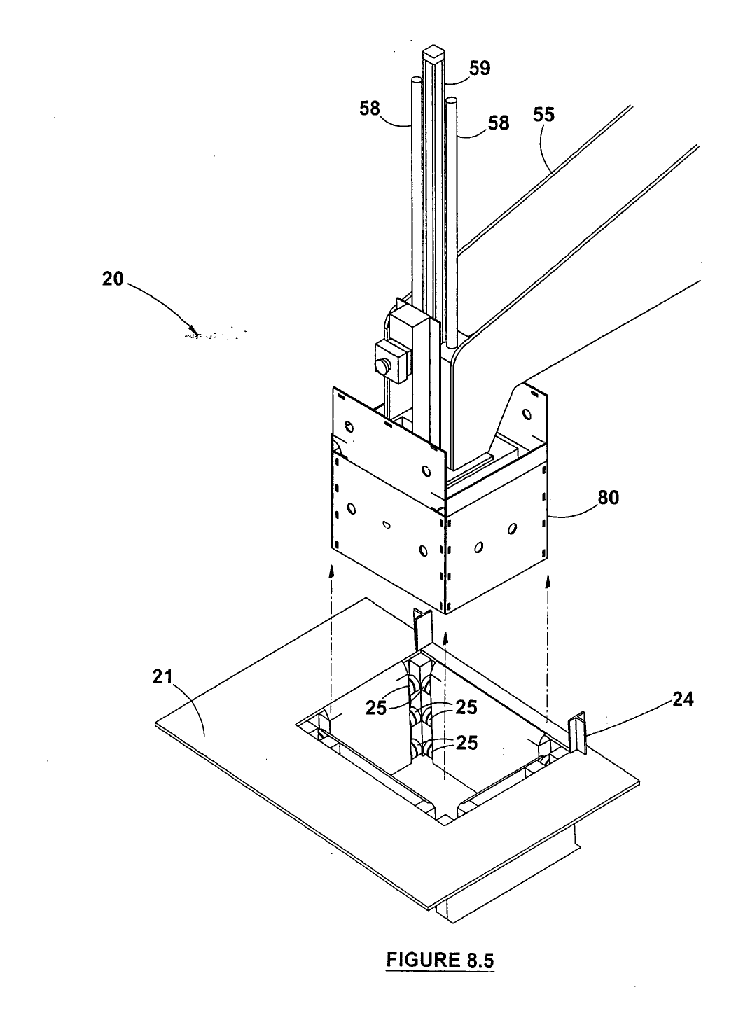

FIGS. 8.1-8.5 illustrate the operations at a second erecting station of the machine;

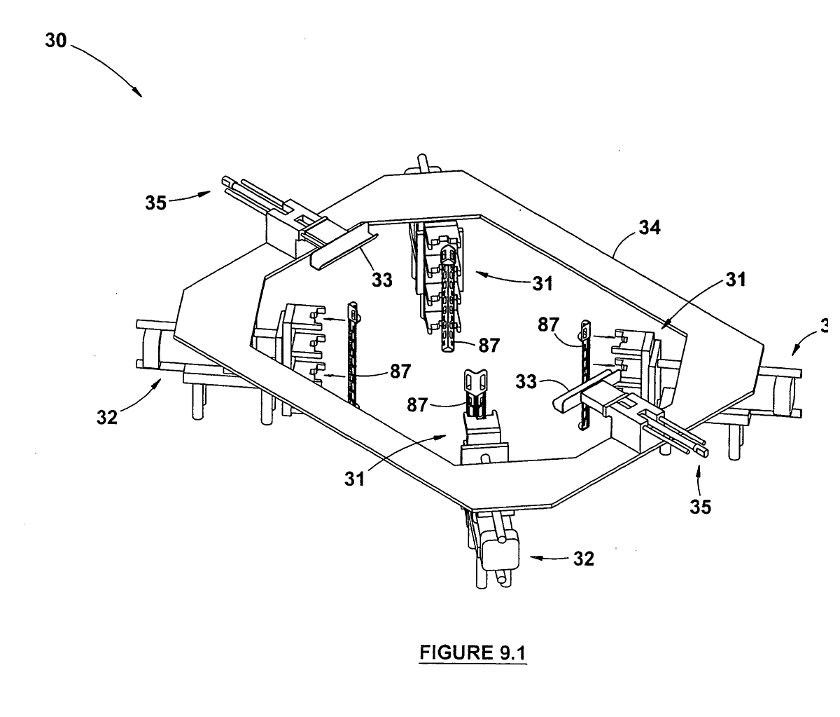

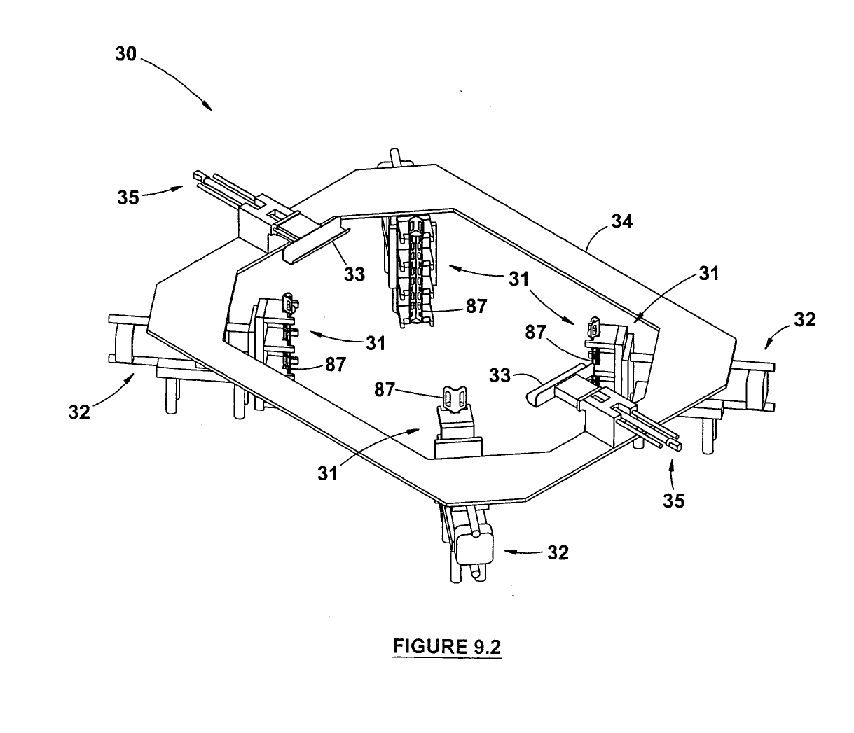

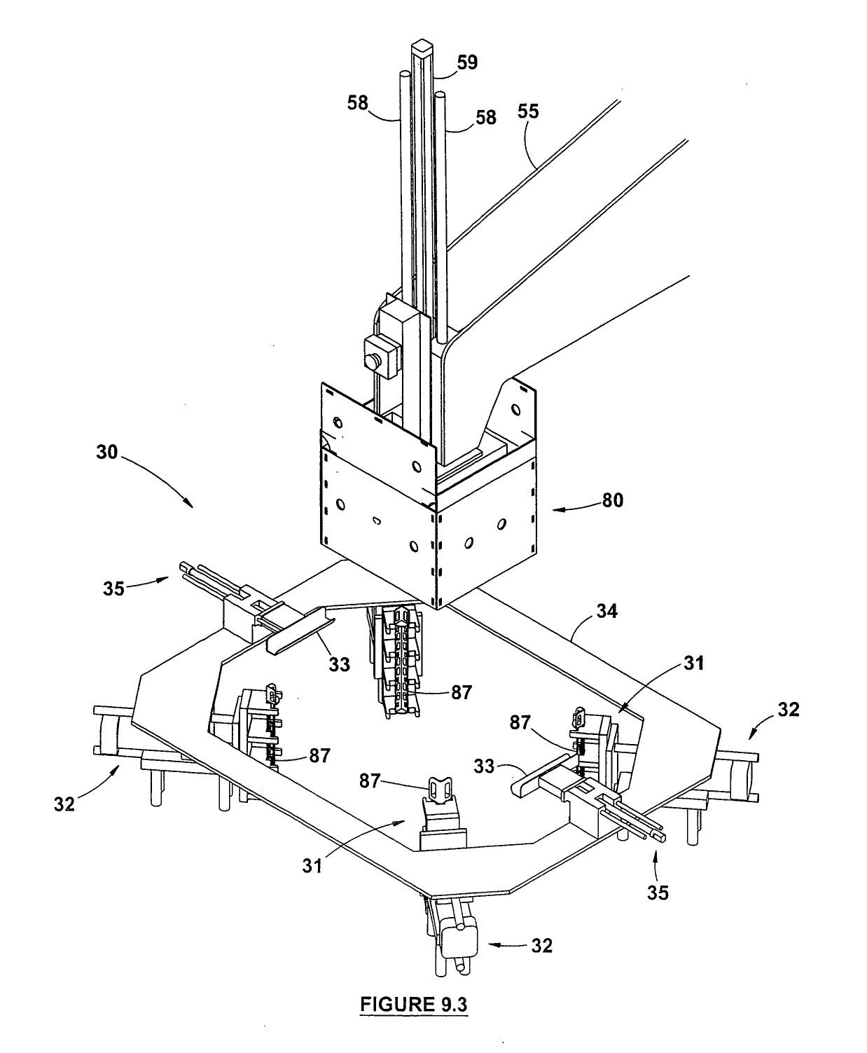

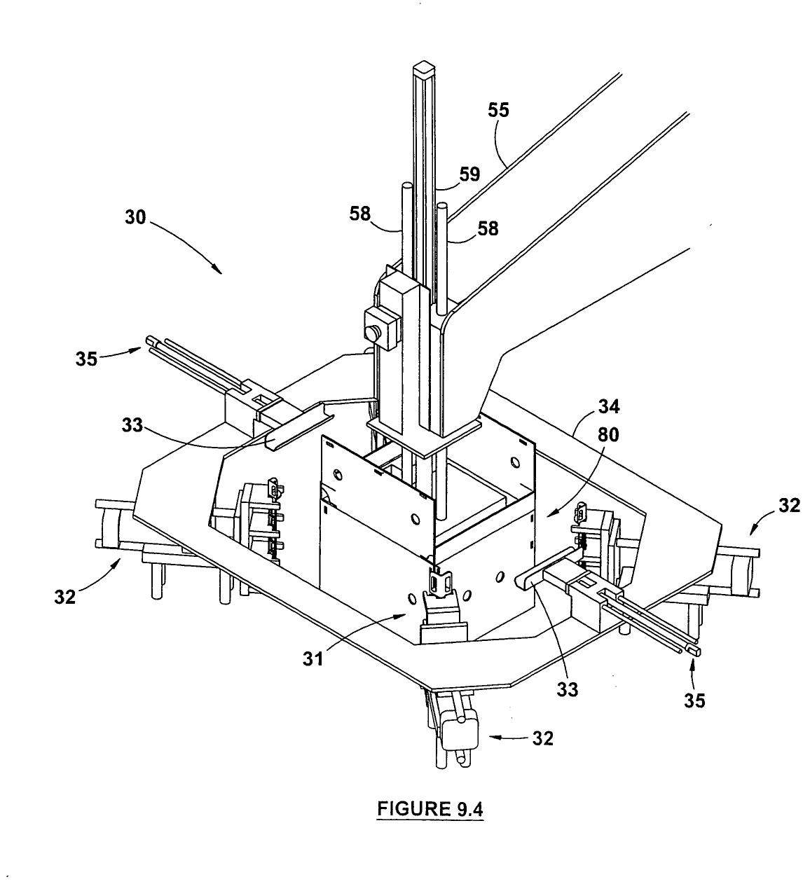

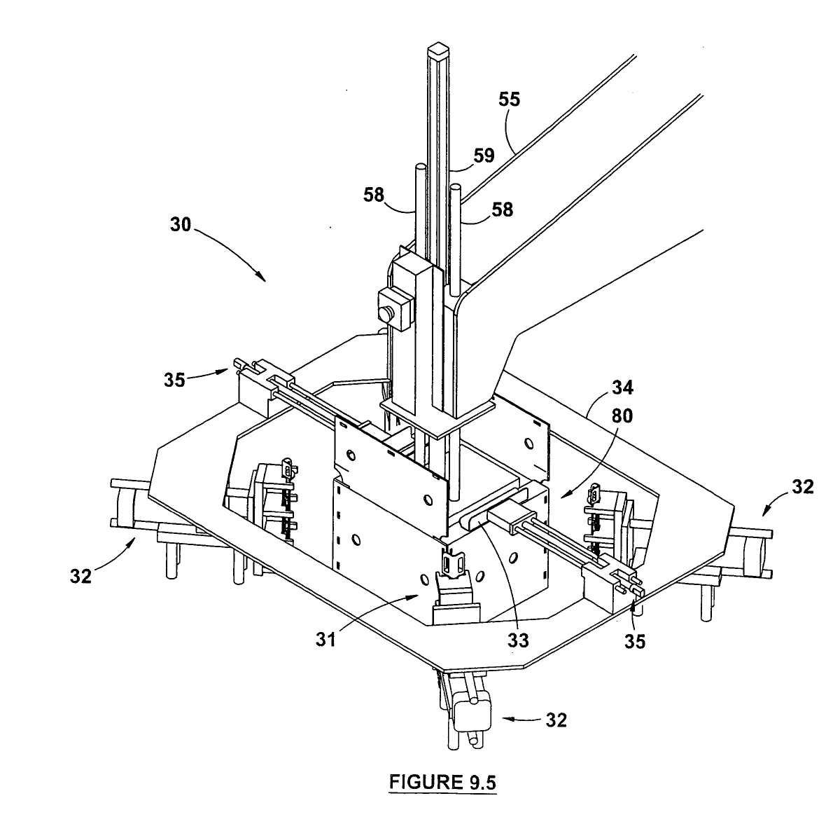

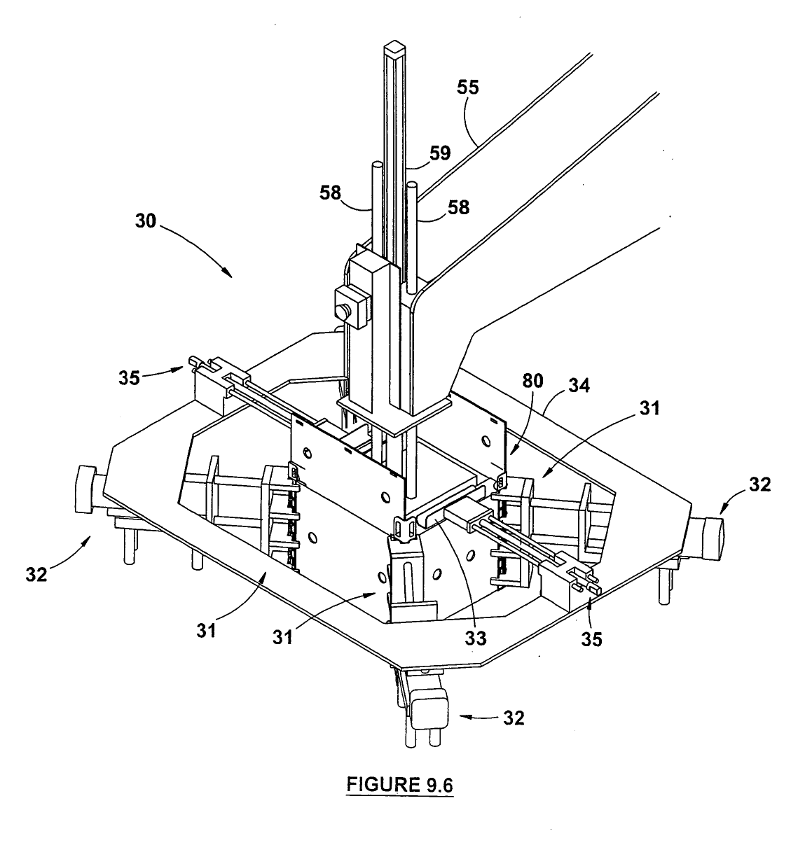

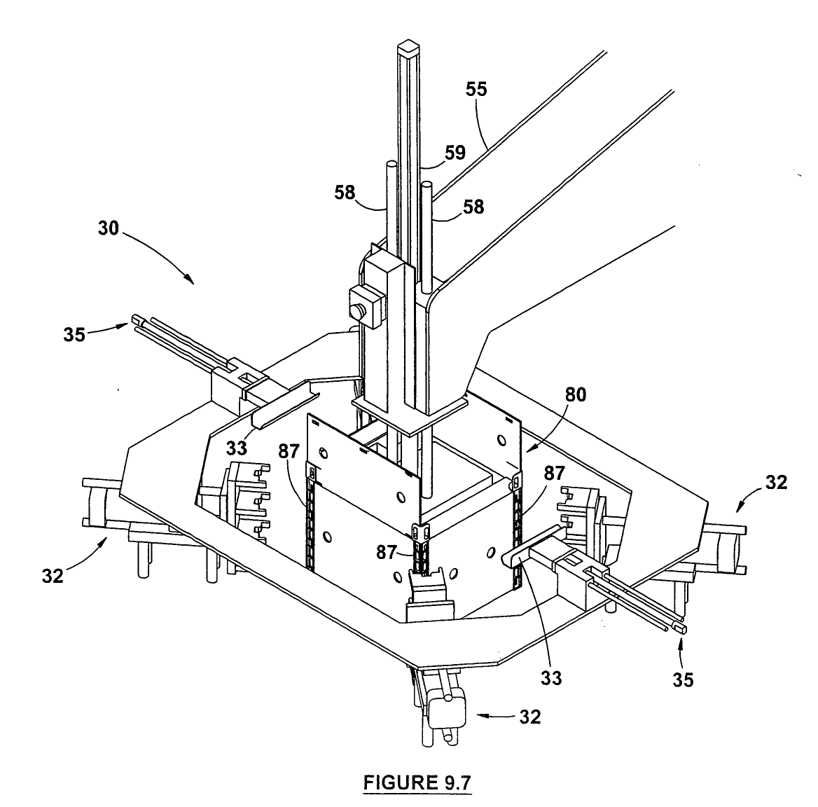

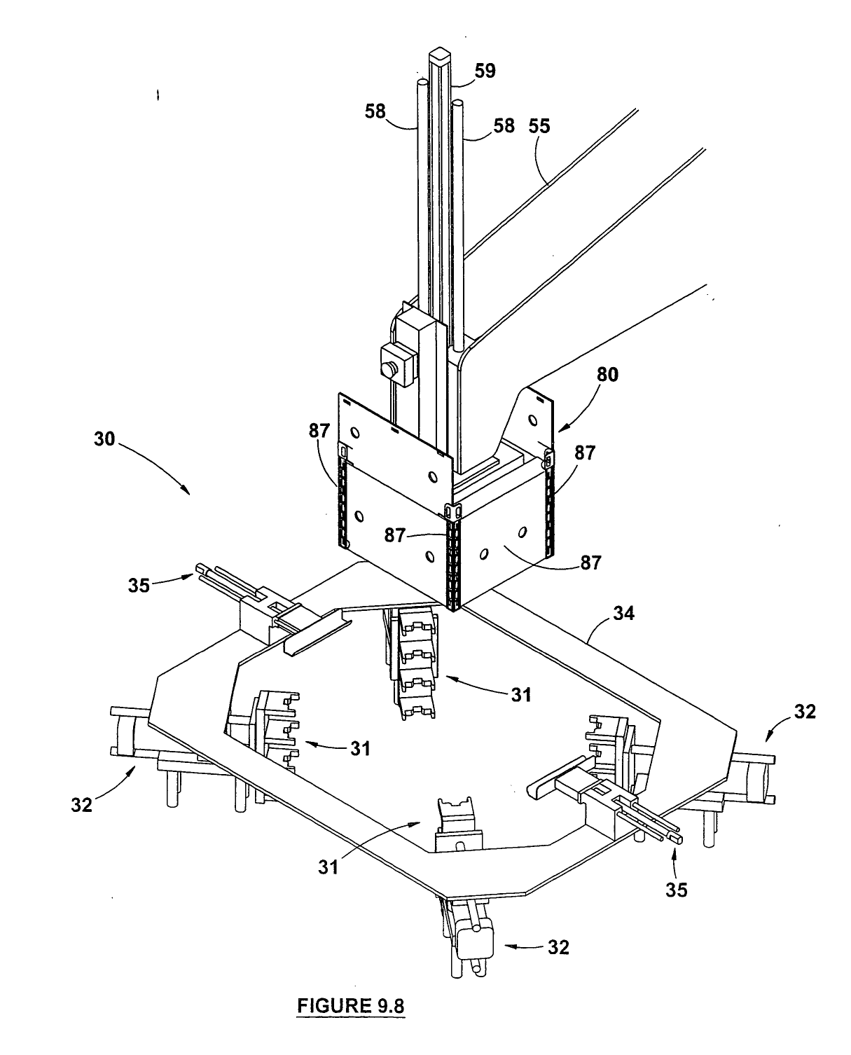

FIGS. 9.1-9.8 illustrate the operations at a third erection station of the machine;

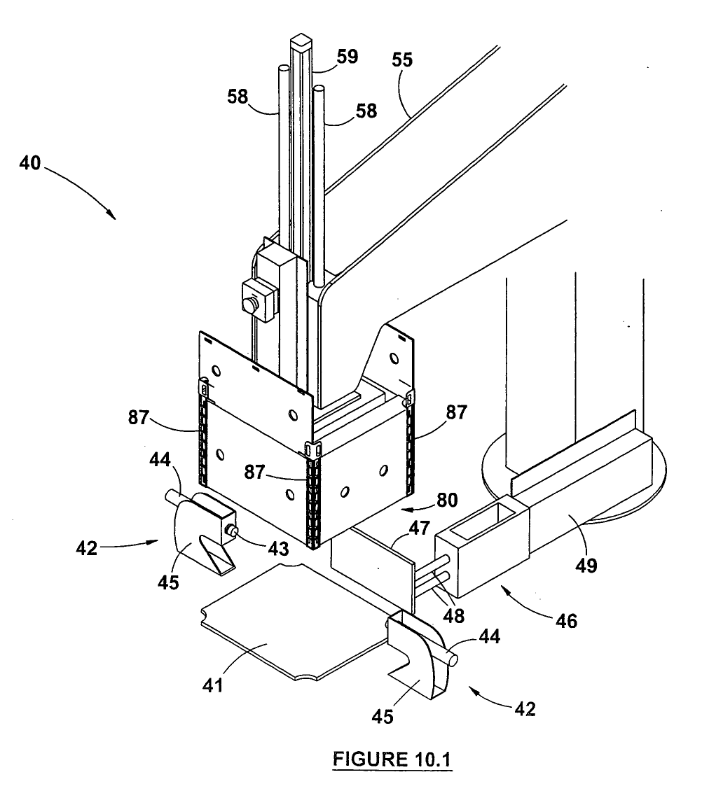

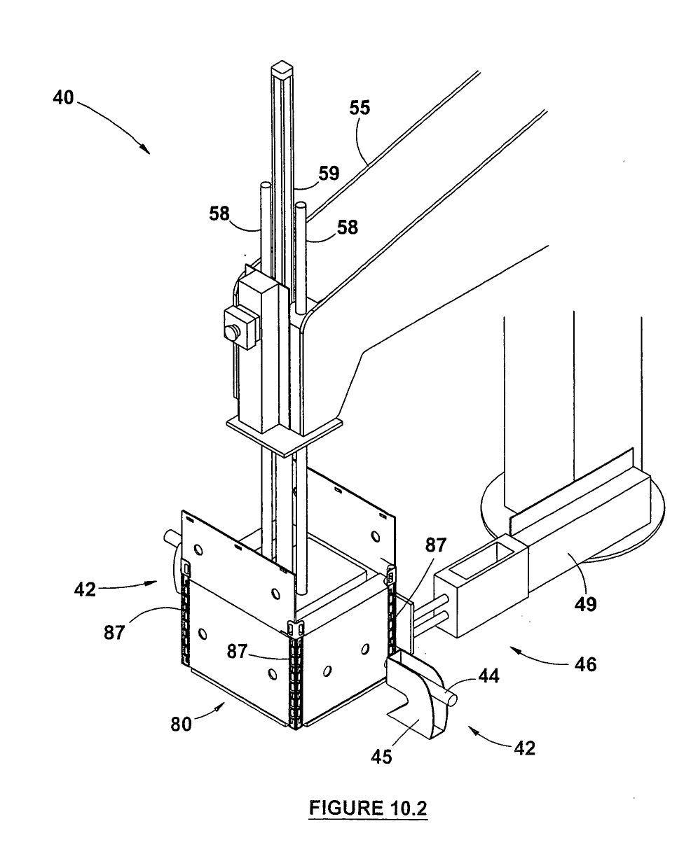

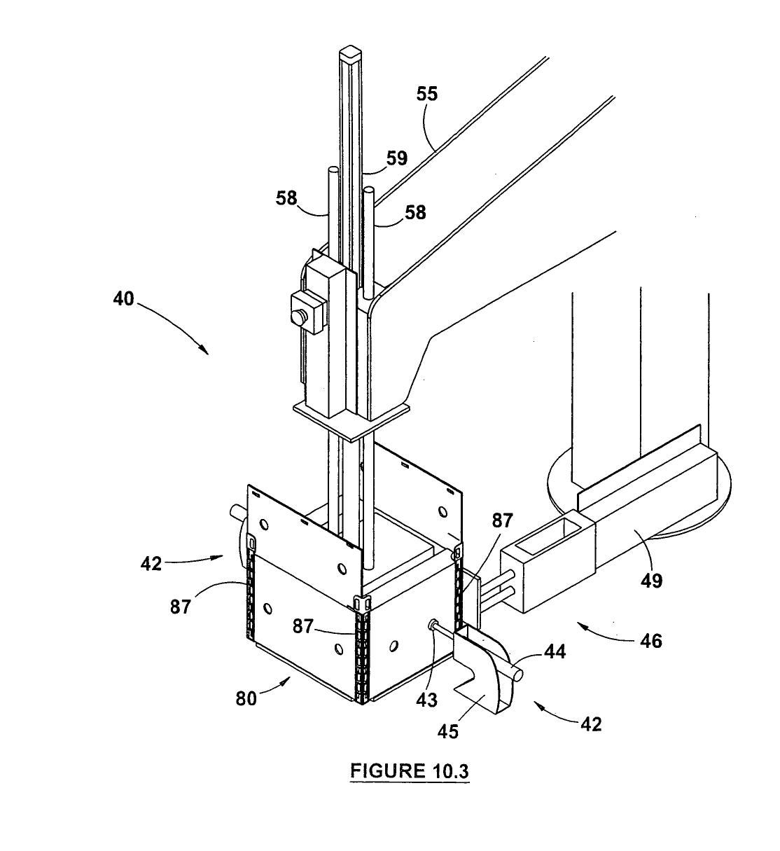

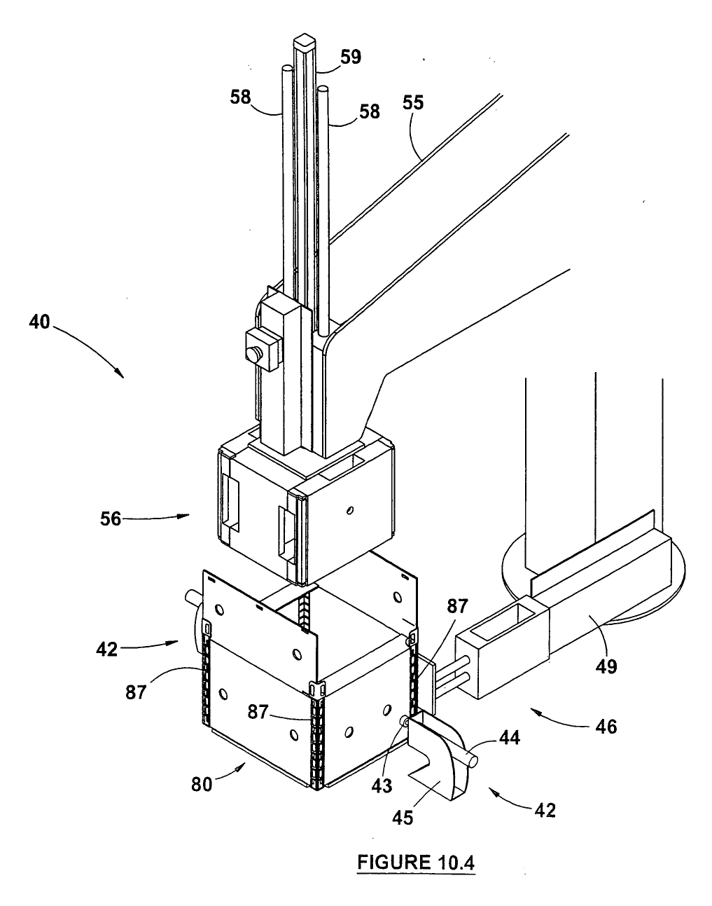

FIGS. 10.1-10.5 illustrate the operations at a fourth erecting station of the machine;

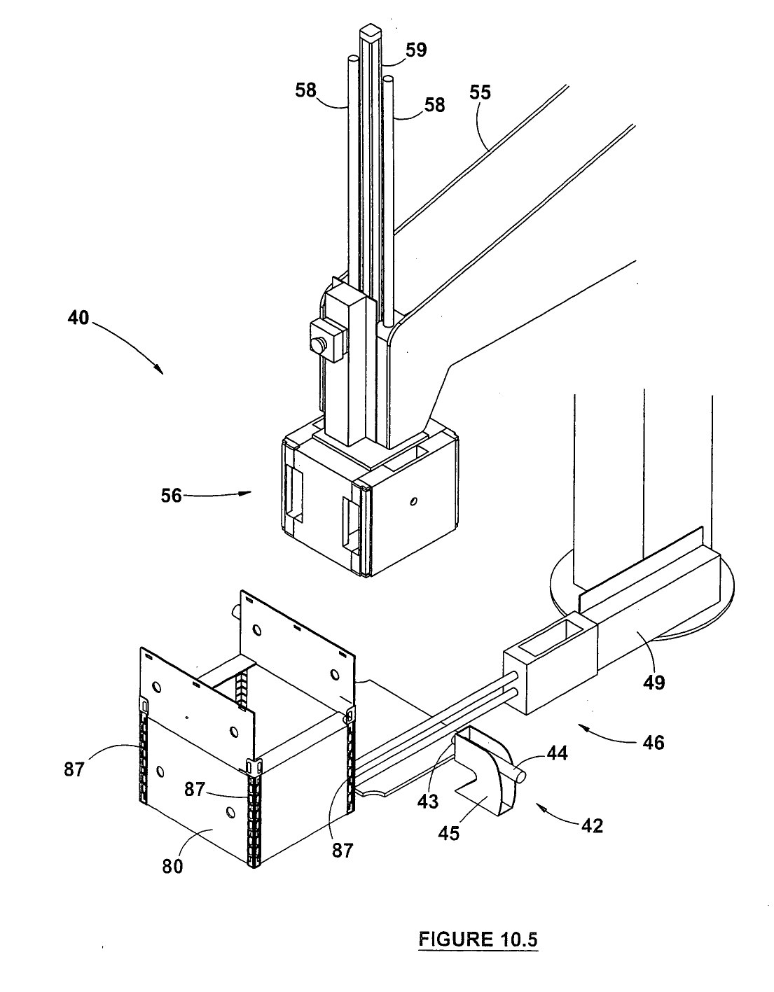

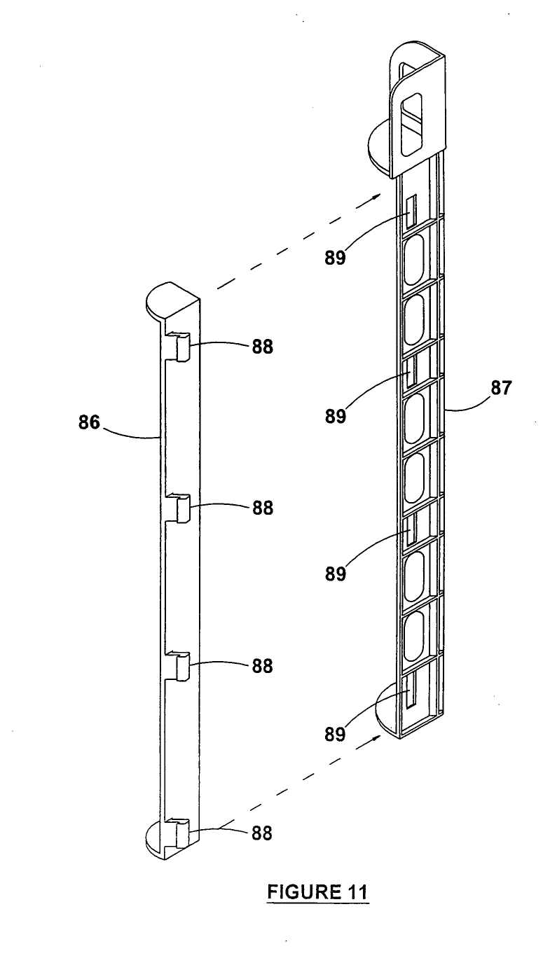

FIG. 11 is a perspective view of the inner and outer parts of an upright corner post used at each of the four corners of a box erected with the use of the machine of the invention;

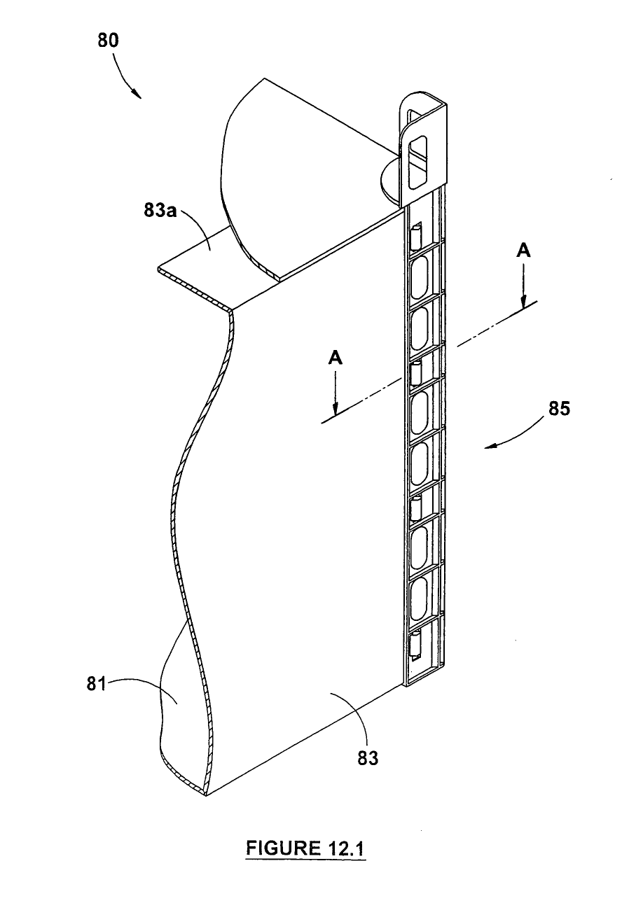

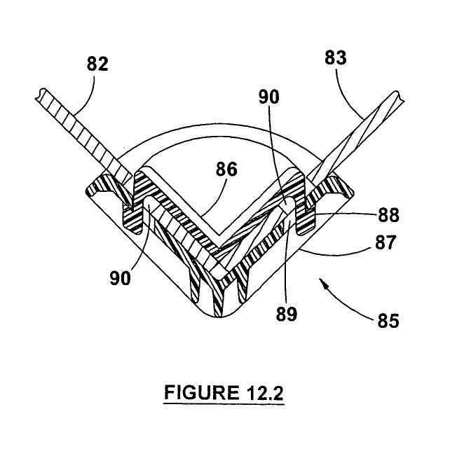

FIG. 12.1 is a similar view of the two parts of the corner post connected together at the corner of such a box;

FIG. 12.2 is an enlarged cross-section taken on lines A-A of FIG. 12.1; and

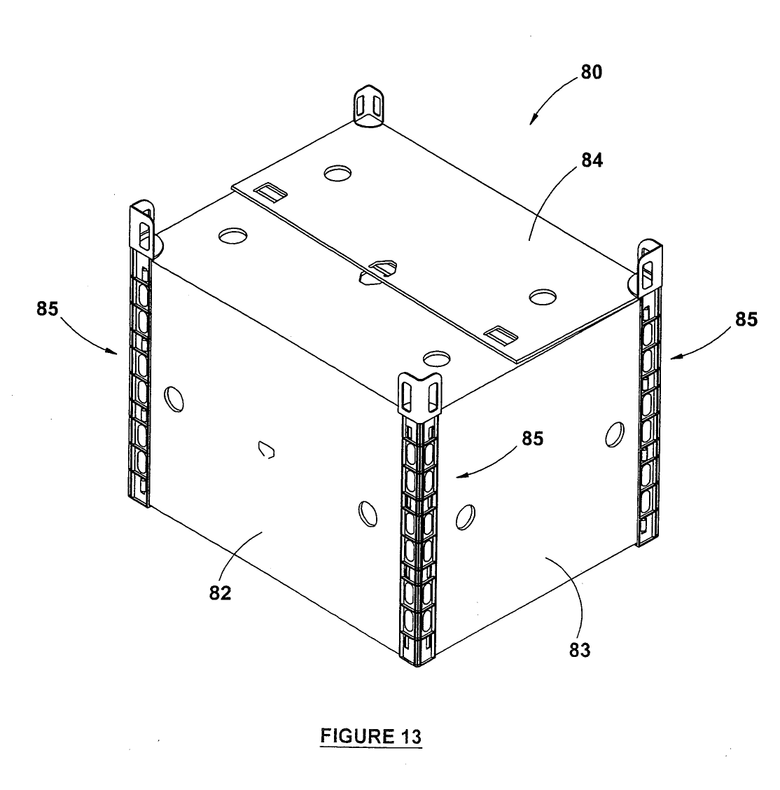

FIG. 13 is a perspective view of a box erected using the machine of invention.

Referring firstly to FIGS. 11-13 of the accompanying drawings, there is shown a rectangular box 80 and its constituent parts. Typically, the box has a base 81, opposed side walls 82, opposed end walls 83 and a pair of openable lids 84, all made from a single blank of sheet material such as polyethylene. The box is held together by four upright corner posts 85, each of which comprises an inner part 86 and an outer part 87. The inner and outer parts 86, 87 are held together by a snap fit in which lugs 88 on the inner part are snap fitted into apertures 89 in the outer part 87. When the inner and outer parts 86, 87 are thus engaged, they trap and hold the ends of the side walls and end walls 82, 83 respectively at each corner of the box 80. As will be most evident from FIG. 12.2, the lugs 88 of the inner part 86 of a post 85 are accommodated in apertures 90 in the side walls and end walls 82, 83 of the box, which apertures are provided along the height of the walls at positions corresponding to the lugs 88 and apertures 89 of the posts 85.

It is for the step-wise erection of a box 80 described above that the box-erecting machine of the present invention is intended.

One embodiment of such a machine, designated by numeral 50 and showing its principal components, is illustrated in FIGS. 1-6.

In this embodiment of the invention, the box-erecting machine 50 comprises a support structure 51 on which is mounted a pillar 52 carrying a rotating head 53 rotatable about a vertical axis 54. The rotating head comprises four equally spaced radial arms 55 each carrying a mandrel 56 in dependent fashion at its free end. Each mandrel 56 is mounted on its associated arm 55 by means of a pair of vertical shafts 58 for vertical displacement relative to the support structure 51. Means are provided for displacing each mandrel by lowering and raising each mandrel, in the form of a pneumatic piston and cylinder assembly 59 located between each pair of vertical shafts 58.

Each mandrel comprises a hub 60 carried by the vertical shafts 58 and a pair of opposed cheek plates 61 mounted on the hub 60 for horizontal displacement away from and towards the hub. Each cheek plate 61 defines a pair of corners 61a of the mandrel, with the two cheek plates 61 defining four corners of the mandrel (FIGS. 1, 7.1).

Displacement of the cheek plates 61 away from a hub 60 results in a mandrel 56 being expanded to an expanded configuration in which the corners 61a are located in a pre-determined expanded formation, as may be seen, for example in FIGS. 1, 2 and 5, 6. Such displacement may be effected by means of hydraulically or pneumatically actuated rods 56a. Displacement of the cheek plates towards the hub 60 results in a mandrel being contracted to a contracted configuration in which the corners 61a are located in a pre-determined contracted formation, as may be seen, for example, in FIGS. 1, 2 and 3, 4. Such displacement is, in this embodiment of the invention, effected by mandrel contracting means 42 as hereinafter described.

Means are provided for rotating the rotating head 53 about the axis 54 in discrete consecutive steps of 90° each, in an indexing fashion. Thus, each mandrel 56 is consecutively located at one of four box-erecting stations designated generally by numerals 10, 20, 30 and 40, to which reference will be made more fully hereunder.

In this embodiment of the invention, the means for rotating the rotating head 53 comprise a chain 70 riding on a cog 71 mounted on the rotating head at its underside. The chain 70 is driven by a gear 72 which itself is driven by an electrical motor 73 (FIG. 3).

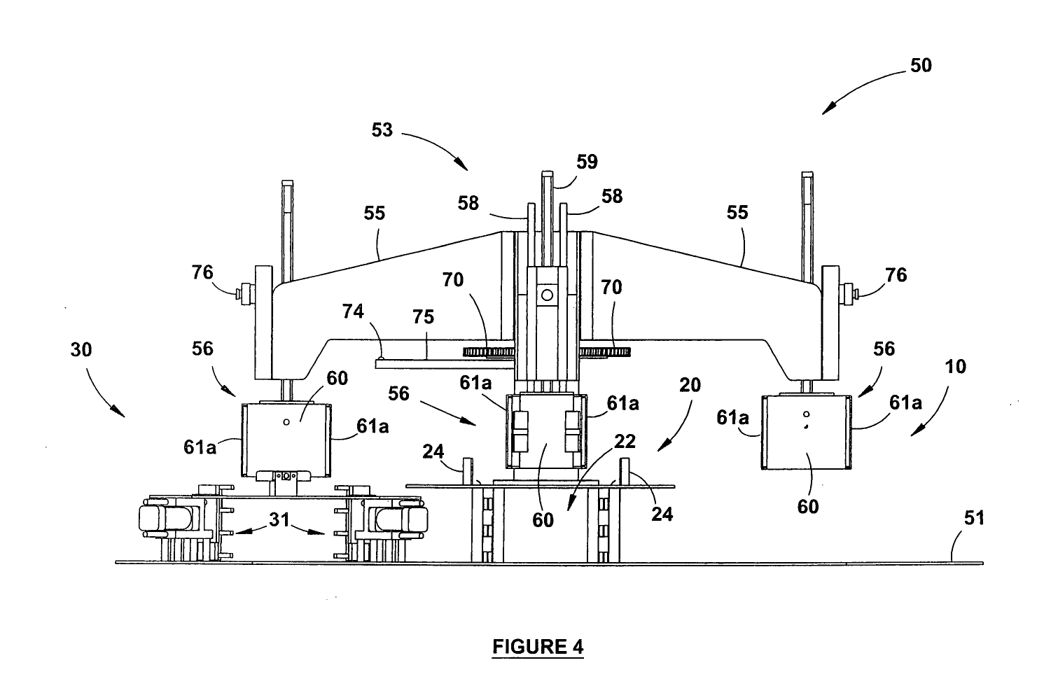

The electric motor 73 is controlled by a sensor 74 mounted on an arm 75 located beneath the rotating head 53 (FIG. 4). The sensor 74 functions in conjunction with sensors (not shown) located on the radial arms 53 to ensure step-wise rotation of the rotating head 53 as described above.

The operation of the box-erecting machine 50 through its four box-erecting stations 10, 20, 30 and 40 will now be described with reference to FIGS. 7-10.

Box-Erecting Station 10

The first box-erecting station is station 10 shown in FIGS. 7.1-7.2. At this station the inner part 86 of a corner post 85 is manually located on each of four corners 61a of a mandrel 56. For this purpose the corners of the mandrel 56 are suitably shaped to receive the inner parts 86. In FIG. 7.1 the inner parts 86 are shown separate from the mandrel and in FIG. 7.2, they are shown located on the four corners of the mandrel.

Box-Erecting Station 20

The second box-erecting station is shown in FIGS. 8.1-8.5. At this box-erecting station a platform 21 is provided surrounding a blank-folding cavity 22. In operation, upon rotation of the rotating head 53, the mandrel 56 from box-erecting station 10 comes to rest above the blank-folding cavity 22 (FIG. 8.1). A diecut and creased blank 23 from which the box 50 is to be formed is located on the platform 21 against stop members 24 (FIG. 8.2). The mandrel 56 is thereupon displaced downwardly into the blank-folding cavity 22, thereby folding the blank 23 into opposed sidewalls 82 and end walls 83 rising from the base 81 of the box 80 (FIGS. 8.3, 12.1).

Next, the mandrel whilst located in the blank-folding cavity is expanded by outward displacement of its cheek plates 61 to its expanded configuration (FIG. 8.4) which serves firmly to locate the inner parts 86 of the corner posts 85 in the four corners of the box 80.

At the same time that the mandrel 56 is displaced downwardly into the blank-folding cavity, pneumatic suction is applied through ports 26 in the cheek plates 61 of the mandrel 56 to facilitate the retention of the now folded blank on the mandrel. The last step at station 20 is withdrawal of the mandrel by means of the piston and cylinder assembly 59 to the former position of the mandrel above the blank-folding cavity 22 (FIG. 8.5). Rotatable rollers 25 are provided in each corner of the blank-folding cavity 22 (FIG. 8.5). The rollers 25 are located at right angles to one another in each corner of the blank-folding cavity to facilitate sliding displacement of the box 80 along each corner when the mandrel is withdrawn form the blank-folding cavity.

Box-Erecting Station 30

The third box-erecting station is shown in FIGS. 9.1-9.8. At this box-erecting station four post-holding devices 31 are provided on the support structure 51, each capable of forward and rearward displacement by means of a pneumatic piston and cylinder assembly 32 (FIG. 9.1). Additionally, a pair of flap-folding devices 33 is provided on a peripheral shelf 34 located above the post-holding devices 31. Each flap-folding device 33 is capable of forward and rearward displacement by means of a pneumatic piston and cylinder assembly 35 (FIG. 9.1).

An outer part 87 of a corner post 85 is manually placed in each of the post-holding devices 31. In FIG. 9.1 the outer parts 87 are shown at the post-holding devices but spaced therefrom and in FIG. 9.2 they are shown as placed in position in the post-holding devices.

In operation, upon rotation of the rotating head 33, the mandrel 56 from the box-erecting station 20 comes to rest at box-erecting station 30 (FIG. 9.3). The mandrel is then displaced downwardly into alignment with the post-holding devices 31 (FIG. 9.4), whereupon the flap-folding devices 33 are operated to fold each of the short flaps 83a of the box 80 inwardly over the mandrel 56 (FIG. 9.5). The post-holding devices 31 are next activated to connect the outer parts 87 of the upright posts 85 to their respective inner parts 86 to complete the construction of the box 80 (FIG. 9.6). The flap-folding devices 33 and post-holding devices 31 are thereupon retracted (FIG. 9.7) and the mandrel is raised to its former position (FIG. 9.8).

Box-Erecting Station 40

The fourth and final box-erecting station 40 is shown in FIGS. 10.1-10.5. At this station a receiving platform 41 is provided between a pair of mandrel collapsing means 42. Each mandrel collapsing means 42 comprises a rod 43 operated by a pneumatic piston and cylinder assembly 44 mounted on a housing 45. Additionally, box-ejecting means 46 are provided comprising an ejecting plate 47 carried on shafts 48 operated by a pneumatic piston and cylinder assembly 49.

In operation, upon rotation of the rotating head 53, the mandrel 56 with its now erected box 80 comes to rest above the receiving platform 41 (FIG. 10.1). The mandrel is lowered on to the receiving platform 41 and the mandrel contracting means 42 are activated which causes each of the rods 43 to advance through an aperture in the end panels 83 of the box 80 and to collapse the cheek plates of the mandrel into its contracted configuration (FIG. 10.3). The rods 43 are withdrawn and the mandrel is raised out of the box 80 to its former position above the receiving platform 41 (FIG. 10.4). The box-ejecting means 46 are activated causing the ejecting plate 47 to eject the box 80 from the receiving platform 41 (FIG. 10.5) on to a conveyor or the like (not shown).

In its operation, manual participation of operators is required for operating the box-erecting-machine 50 described above. Typically, two operators could be positioned at each of the first and third stations 10, 30 and one operator at the second station 20. Safeguards can be included in the machine to prevent accidental or untimely rotation of the rotating head 53. For example, if there are two operators at station 30 inserting outer parts of the corner posts 85, dual switches (not shown) can be provided requiring that both operators press a switch before the rotating head is rotated. So too, a stop switch 76 is provided on each radial arm 55 which can be pressed by any operator ay any time to stop all operations of the machine.

Other embodiments of the invention may be made differing in matters of detail and without departing from the scope of the invention as described in the appended claims.

1. A box-erecting machine comprising a support structure and a rotatable head mounted on the support structure for rotation about an axis, the rotatable head carrying a plurality of four-cornered mandrels, means for displacing each mandrel away from and towards the rotatable head, and means for rotating the rotatable head in discrete steps so as to locate each mandrel at consecutive erecting stations of the machine and thereby to permit progressive erection of a rectangular box through the erecting stations from a blank of sheet-like material with corner posts located and connected in each of the four corners of the box.

2. A box-erecting machine as claimed in claim 1 in which each mandrel comprises a plurality of displaceable parts defining the corners of the mandrel, each mandrel being expandable to an expanded configuration in which the corners are located in a pre-determined expanded formation, and contractable to a contracted configuration in which the corners are located in a pre-determined contracted formation.

3. A box-erecting machine as claimed in claim 1, including
a first erecting station at which an inner part of a corner post is locatable on each of the four corners of a mandrel;
a second erecting station including a platform surrounding a blank-folding cavity, the mandrel being displaceable into the cavity to fold a blank located on the platform into a rectangular box consisting of a base, two opposed side walls and two opposed end walls, the mandrel being expandable within the cavity to its expanded configuration to locate the inner parts of the corner posts in the four inner corners of the rectangular box, the mandrel, with the box, being displaceable from the box-folding cavity;
a third erecting station including four post-holding devices, an outer part of a corner post being locatable in each post-holding device, the mandrel, carrying the box, being displaceable into alignment with the post-holding devices, the post-holding devices being simultaneously displaceable towards the mandrel to connect each outer part of each post with its respective inner part located in the box and thereby to trap and hold the walls of the box by means of the corner posts, the post-holding devices being retractable and the mandrel being displaceable from its position adjacent the post-holding devices, and
a fourth erecting station including a receiving platform, the mandrel being displaceable to locate the box on the receiving platform, the mandrel being contractable to its contracted configuration, thereby releasing it from the box, the mandrel being displaceable from the receiving platform, box-ejecting means being provided for ejecting the box from the receiving platform onto a conveyor or the like.

4. A box-erecting machine as claimed in claim 1 in which the rotating head comprises four equally spaced radial arms each carrying a mandrel in dependent fashion.

5. A box-erecting machine as claimed in claim 4 in which each mandrel is mounted on its associated arm by means of a pair of vertical shafts for vertical displacement relative to the support structure of the machine.

6. A box-erecting machine as claimed in claim 5 in which each mandrel comprises a central part carried by the vertical shafts and a pair of opposed cheek plates defining the four corners of the mandrel, the cheek plates being mounted for horizontal displacement away from and towards the central part to permit expansion and contraction of the mandrel respectively.

7. A box-erecting machine as claimed in claim 5 in which the means for displacing and retracting each mandrel comprise a pneumatic piston and cylinder assembly mounted between each pair of shafts.

8. A box-erecting machine as claimed in claim 1 in which means for rotating the rotating head comprises electric drive means arranged to rotate the rotatable head through consecutive 90 steps in an indexing fashion to locate each mandrel consecutively at each erecting station of the machine.

9. A method of erecting a box comprising,
providing a box-erecting machine having a support structure and a rotatable head mounted on the support structure for rotation about an axis, the rotatable head carrying a plurality of four-cornered mandrels, means for displacing each mandrel away from and towards the rotatable head, and means for rotating the rotatable head,
rotating the head in discrete steps so as to locate each mandrel at consecutive erecting stations of the machine, and
progressively erecting the box through the erecting stations from a blank of sheet-like material to provide corner posts located and connected in each of the four corners of the box.
